(19) United States
(12) Patent Application Publication
(10) Pub. No.: US 2017/0343413 A1
(43) Pub. Date: Nov. 30, 2017

(54) PATTERNING APERTURE SLIT DEVICE AND MOUNTING ASSEMBLY FOR SPECTROMETRY

(71) Applicant: Ocean Optics, Inc., Largo, FL (US)

(72) Inventor: Paul W. Ave, Orlando, FL (US)

(21) Appl. No.: 15/667,686

(22) Filed: Aug. 3, 2017

Related U.S. Application Data
(63) Continuation-in-part of application No. 14/834,631, filed on Aug. 25, 2015.
(60) Provisional application No. 62/045,052, filed on Sep. 3, 2014.

(51) Int. Cl. G01J 3/04; G01J 3/02

(52) U.S. Cl. CPC G01J 3/04; G01J 3/0289; G01J 3/0297

(57) ABSTRACT

A device for improving the removal of stray light interference in a spectrometer using an aperture slit with a predefined grid pattern incorporated into it and a mounting assembly for proper alignment to the spectrometer's 2D detector to create periodic shadowing allowing the identification of the desired signal and removal of stray light is disclosed.

### CROSS-REFERENCE TO RELATED APPLICATION

The present application claims the benefit of previously filed Provisional Patent Application, Ser. No. 62/045,052, filed on Sep. 3, 2014; and, co-pending Utility patent application Ser. No. 14/834,631, filed on Aug. 25, 2015.

### FIELD OF THE INVENTION

The device of this disclosure belongs to the field of manufacture of spectrometers. More specifically it is a new patterning aperture slit device and mounting assembly to improve stray light interference avoidance.

### BACKGROUND OF THE INVENTION

It is well known by those skilled in the art that the accuracy of spectroscopic measurements are hindered by what is known as stray light. A new approach to suppression of interfering stray light was discussed in the paper, “Stray Light Suppression in Spectroscopy Using Periodic Shadowing”, by Kristensson et al. that was published 7 Apr. 2014 in Vol. 22, No. 7, Optics Express 7711 through 7721 by the Optical Society of America.

This new method of stray light suppression involved the placing of a Ronchi grid in front of the entrance slit creating periodic shadowing with a given spatial frequency and phase along the slit direction. The stray light is unable to maintain this structure and thus the signal to be studied can be identified and separated from the stray light by a detection algorithm well known to those skilled in the art.

The novel improvement in periodic shadowing of this disclosure over Kristensson et al involves the use of a prefabricated slit which has a predefined grid pattern incorporated into the slit and a mounting assembly to ensure proper alignment with the spectrometer's 2D detector.

### BRIEF SUMMARY OF THE INVENTION

This invention is a device for improving the removal of stray light interference in a spectrometer using an aperture slit with a predefined grid pattern incorporated into it along with a mounting assembly to ensure proper alignment with the spectrometer's 2D detector to create properly spaced and aligned periodic shadowing allowing the identification of the desired signal and removal of stray light.

### BRIEF DESCRIPTION OF THE DRAWINGS

For a fuller understanding of the nature and objects of the invention, reference should be made to the following detailed description, taken in connection with the accompanying drawings, in which:

FIG. 1 shows a diagram of one embodiment of the patterning aperture slit device made for mounting in a spectrometer mounting assembly;

FIG. 2 shows a front view diagram of one embodiment of the patterning aperture slit device;

FIG. 3 shows a perspective view diagram of one embodiment of the patterning aperture slit device; and,

FIG. 4 shows the spectrometer mounting assembly of the preferred embodiment for aligning the patterning aperture slit device correctly to the spectrometer's 2D detector for creating properly aligned periodic shadowing.

### DESCRIPTION OF THE PREFERRED EMBODIMENT

As discussed above a new method of stray light suppression involving the placing of a Ronchi grid in front of the entrance slit creating periodic shadowing with a given spatial frequency and phase along the slit direction has been disclosed in the prior art. The stray light is unable to maintain this structure and thus the signal to be studied can be identified and separated from the stray light by a detection algorithm well know to those skilled in the art.

The device of this disclosure that is creating the properly aligned and spaced periodic shadowing is the result of the use of a prefabricated patterning aperture slit device (1) which has an aperture slit (2) with a predefined grid pattern (3) incorporated into it.

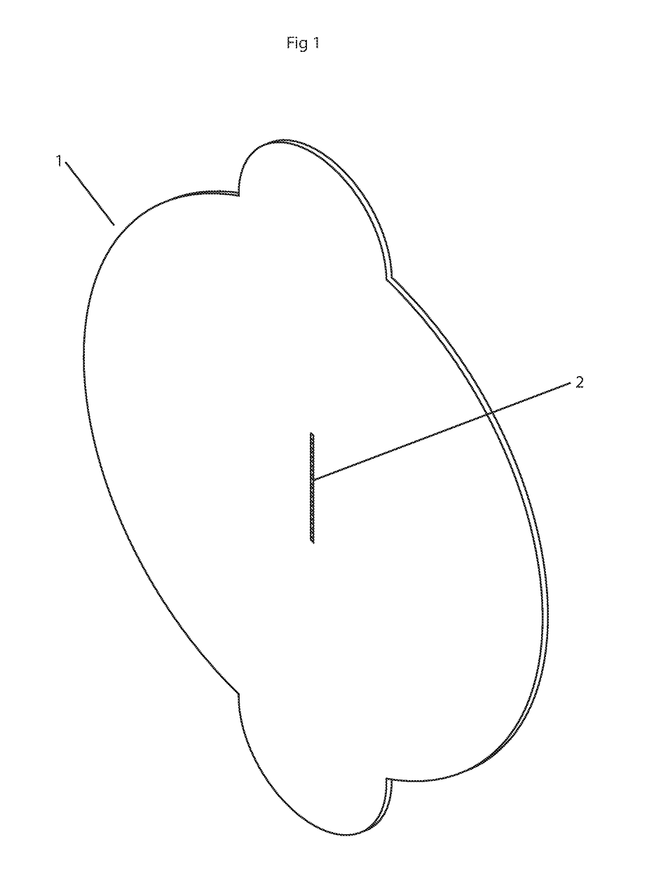

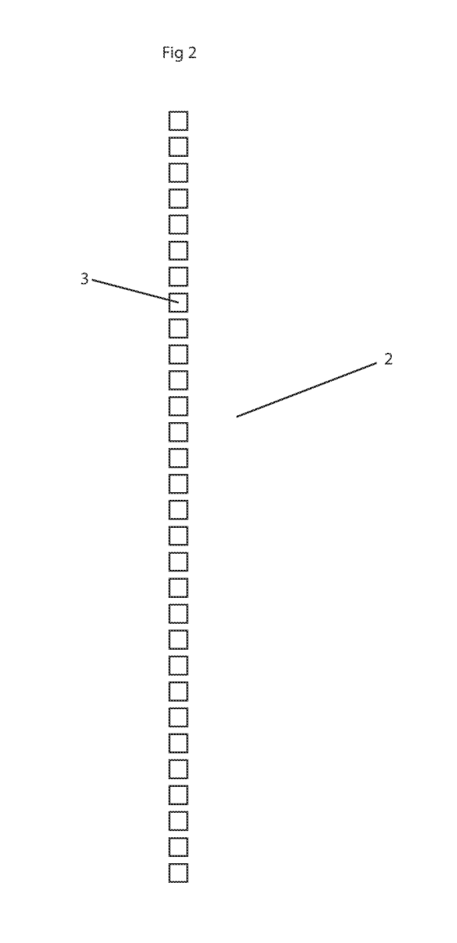

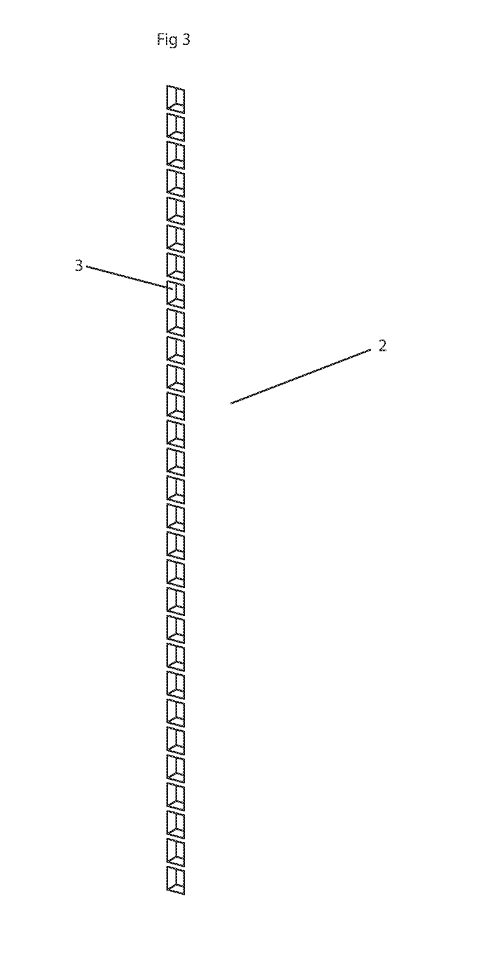

As shown in FIGS. 1, 2, and 3, this patterning aperture slit device (1) is constructed by incorporating into the aperture slit (2) a predefined grid pattern (3) which, when used in spectroscopy, creates a periodic shadowing of the light signal desired to be measured and wherein the properly spaced pattern of periodic shadowing is created by the patterning aperture slit device when the resolution of the grid pattern is matched to the resolution of the detector in a spectrometer as can be easily determined by those skilled in the art, and thus allows for the identification and removal of stray light by use of a Fast Fourier Transform (FFT) processing algorithm known to those skilled in the art since the stray light will not adhere to the shadowing pattern. More specifically the patterned light produced by the patterning aperture slit device (1) identifies the original spectral image source that is projected onto the 2D detector. But even the patterned image will contain stray light since it comes from various reflected surfaces within the optical bench. To effectively eliminate this stray light the patterned “light” is mathematically segregated (via an FFT by array column) from the 2D detector array. The dark patterned areas in between the lighted patterns will be subtracted from the light areas to eliminate the stray light component. Finally the lighted areas are mathematically summed by the 2D detector array column to give a corrected response. Thus it is clear that to effectively eliminate stray light using the patterning aperture slit device (1) of this disclosure the device (1) must be mounted to the spectrometer in a manner that allows for proper alignment, orientation and tolerancing as described below.

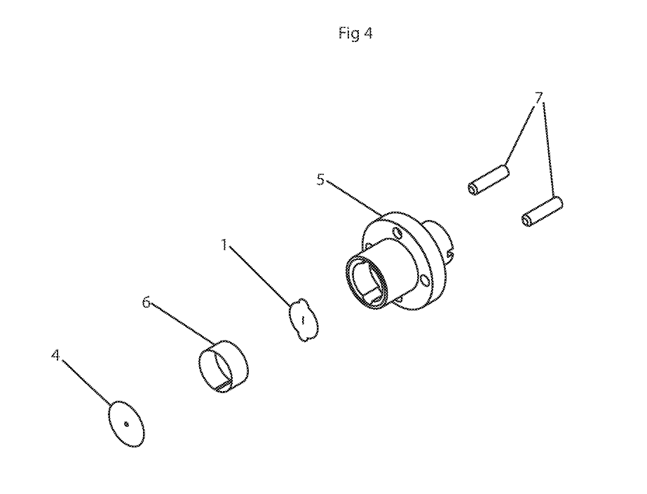

FIG. 4 shows the spectrometer mounting assembly comprising the aperture (4), the aperture retaining ring (6), the spectrometer bulkhead connector (5), and alignment dowels (7), used to properly align the patterning aperture slit device (1) produced in accordance with FIGS. 1, 2, and 3. This mounting assembly provides an effective and repeatable means to inject a resolution matched (as described above) “patterned” light image into the spectrometer unit and on to the 2D detector of the spectrometer with the proper alignment, orientation and tolerancing required for calibration and subsequent stray light rejection accomplished via post processing. To accomplish this proper alignment, orientation and tolerancing of the periodic shadowing the mounting assembly is also designed to be matched to the spectrometer's ultimate optical focal ratio (“F number”). More specifically for the preferred embodiment the mounting assembly is designed with the aperture (4) spaced at a specific distance from the patterning aperture slit (1). The distance of the aperture (4) from the patterning aperture slit (1) divided by the diameter of the aperture (4) gives an F#4 focal ratio, which is designed to match the spectrometer's optical train.

Since certain changes may be made in the above described patterning aperture slit device and mounting assembly without departing from the scope of the invention herein involved, it is intended that all matter contained in the description thereof or shown in the accompanying figures shall be interpreted as illustrative and not in a limiting sense.

What is claimed is:

1. A periodic shadows pattern forming aperture slit device and mounting assembly that facilitates proper periodic shadows spacing and alignment and the removal of stray light interference from a light signal being measured through an aperture slit by a 2D detector in a spectrometer comprising:
a periodic shadows pattern forming aperture slit device having a periodic shadows pattern forming grid pattern integrated into and extending the length of said aperture slit wherein the resolution of said grid pattern matches the resolution of said 2D detector; and
a mounting assembly for holding and aligning said periodic shadows pattern forming aperture slit device to said spectrometer.

2. The device and assembly of claim 1 wherein said mounting assembly that that holds said pattern forming aperture slit in alignment with said spectrometer's 2Ds detector is comprised of an aperture, an aperture retaining ring, a spectrometer bulkhead connector, and one or more alignment dowels.

3. The device and assembly of claim 2 wherein the distance in said mounting assembly between said aperture and said pattern forming aperture slit divided by the diameter of said aperture is designed to match said spectrometer's optical train.
